(19) United States
(12) Patent Application Publication
(10) Pub. No.: US 2024/0399978 A1
(43) Pub. Date: Dec. 5, 2024

(54) TRIM PART FOR A VEHICLE INTERIOR

(71) Applicant: Faurecia Innenraum Systeme GmbH, Hagenbach (DE)

(72) Inventors: René Zemmrich, Hagenbach (DE); Sabine Lindemann, Hagenbach (DE)

(21) Appl. No.: 18/616,879

(22) Filed: Mar. 26, 2024

(30) Foreign Application Priority Data
May 31, 2023 (DE) 10 2023 205 085.4

(51) Int. Cl. B60R 13/02

(52) U.S. Cl. CPC B60R 13/02; B60R 2013/0281

(57) ABSTRACT

A trim part for a vehicle interior, comprising a carrier element with a recess, an operating element arranged at least partially in the recess operable from a front side of the trim part, and a partially light-transmissive cover layer arranged on the front side of the trim part covering the recess. The cover layer is supported on and/or flatly connected to the carrier element in a contact region. An air gap is formed between the operating element and the cover layer and/or the carrier element. A first part of a visible surrounding light passing through the cover layer from the front side of the trim part is reflected in the contact region and a second part of the surrounding light is reflected in a region of the air gap. The reflected first part and second part of the surrounding light have substantially the same brightness and/or color after passing through the cover layer.

### PRIORITY APPLICATIONS

This application claims the benefit of priority of German Application Serial No. 10 2023 205 085.4, filed May 31, 2023, which is hereby incorporated by reference in its entirety.

### TECHNICAL FIELD

The application relates to a trim part for a vehicle interior.

### BACKGROUND

Trim parts for vehicle interiors may be designed in such a manner that an operating element arranged in or behind them, with which a function of the vehicle can be operated, is visible as little as possible (so-called “shy tech”). For example, control buttons on a dashboard can visually “disappear”, when an integrated light source emits no light. In another example, operating elements with a so-called black panel effect wherein a cover layer, such as a flexible material layer, covers an operating element, such as a pushbutton, in such a manner that the operating element is not visible or is barely visible when a light-emitting diode integrated in the operating element does not emit any light. Cover layers with a very low transmittance of significantly less than 5 percent, for example, are used for this purpose. Due to the low transmittance required, this solution is less suitable for light sources with lower luminance, in particular common display elements such as LCD displays or OLED displays. However, if a cover layer with higher transmittance is used, the operating element located behind the cover layer can be comparatively clearly visible.

### SUMMARY

Disclosed herein is a trim part which enables the operating element to be seen as little as possible.

The proposed trim part for a vehicle interior may comprise a carrier element with a recess, and an operating element arranged at least partially in the recess of the carrier element and operable from a front side of the trim part. The trim part may further comprise a partially light-transmissive cover layer arranged at the front side of the trim part, the cover layer covering the recess. The cover layer may be supported on and or flatly connected to the carrier element in a contact region surrounding the recess and wherein an air gap is formed between the operating element and the cover layer and/or the carrier element so that a first part of a visible surrounding light, which passes through the cover layer from the front side of the trim part, is reflected in the contact region and a second part of the surrounding light is reflected in the region of the air gap. At least one optical property of the contact region may be selected in such a manner that the reflected first part of the surrounding light and the reflected second part of the surrounding light have, after passing through the cover layer, substantially the same brightness and/or substantially the same color.

By selecting the at least one optical property of the contact region in this manner, low visibility of the operating element can be achieved, in particular even if a transmittance of the cover layer for the surrounding light is comparatively high. This makes the proposed solution suitable in particular for situations in which the operating element is to be made visible through the cover layer in certain operating states by a light source with comparatively low luminance, for example an LCD display or OLED display. Air gaps of this type are unavoidable in the design of operating elements, such as buttons or pushbuttons, which are movably arranged behind the cover layer. Since optical properties of the air in such air gaps, such as a refractive index, differ from corresponding optical properties of the components that are in contact with the cover layer in the contact region (such as a surface of the carrier element and/or an adhesive), there may be differences between the visual appearance of the cover layer in the contact region and in the region of the air gaps. Differences in the absorption behavior of the components that are in contact with the cover layer in the contact region on the one hand and the components arranged in the region of the air gap under the cover layer on the other hand can also contribute to such visual differences. By selecting one or more optical properties of the contact region in the manner mentioned, such visual differences can be reduced or avoided.

The aforementioned brightness and/or color of the reflected first part of the surrounding light and the reflected second part of the surrounding light can be indicated for quantification by parameters of a color parameterization, for example as color locations in the L*a*b* color space, and/or can be measurable by means of a color measuring device, such as a spectrophotometer or spectroradiometer or reflectometer. The property of having substantially the same brightness and/or substantially the same color can be specified by a maximum deviation of one or more parameters of a color parameterization, such as coordinates in the L*a*b* color space. In particular, the property of having substantially the same brightness and/or substantially the same color can be defined in particular in such a manner that a distance between two color locations in the L*a*b* color space, referred to as ΔE*_{ab}, is less than a specified distance limit value. The distance is calculated using the following formula (geometric addition of the distance components ΔL*, Δa*, Δb*):

$$Δ {E}_{ab}^{*} = \sqrt{Δ {L}^{{*}^{2}} + Δ {a}^{{*}^{2}} + Δ {b}^{{*}^{2}}}$$

A distance of ΔE* less than 1 is no longer perceptible to the human eye. The specified distance limit value is preferably 1, but can also be set higher, for example in the range of over 1 to 2.5, or lower, for example in the range of 0.5 to under 1.

The at least one optical property of the contact region can be given at least in part by a color and/or a reflectance and/or a transmittance and/or an absorbance and/or a reflection spectrum and/or an absorption spectrum of a material of the carrier element. In this manner, the required optical property can be selected or achieved by means of minor design adjustments, such as an admixture to the material of the carrier element.

The at least one optical property of the contact area can be given at least in part by a color and/or a reflectance and/or a transmittance and/or an absorbance and/or a reflection spectrum and/or an absorption spectrum of an intermediate layer arranged between the cover layer and the carrier element in the contact region. This allows the required optical property to be selected or achieved in a simple and flexible manner.

The intermediate layer can be applied to a side of the cover layer facing the carrier element, in particular applied with a material bond, and/or flatly connected thereto. The intermediate layer can be applied to a side of the carrier element facing the cover layer, in particular applied with a material bond, and/or flatly connected thereto.

The intermediate layer can be or comprise a color layer and/or an adhesive layer, in particular an adhesive layer with an admixture of color pigments. This allows the required optical property to be selected or achieved in a particularly simple and flexible manner. The intermediate layer can be and/or comprise a textile layer and/or a plastic layer and/or a film layer.

An air gap formed between the carrier element and the operating element can be at least partially, preferably completely, covered by the intermediate layer. An air gap formed between the carrier element and the operating element may be more difficult to make “invisible” by means of a choice of the at least one optical property of the contact region than an air gap formed between the operating element and the cover layer; this can be simplified by means of covering this air gap with the intermediate layer (which can effectively be regarded as enlarging the contact region). In this case, the intermediate layer acts as a masking layer that masks the air gap formed between the carrier element and the operating element and influences the reflection behavior in the region of this air gap with regard to the surrounding light by suitably selecting at least one optical property of the intermediate layer.

The at least one optical property of the contact region can be given in part by a color and/or a reflectance and/or a transmittance and/or an absorbance and/or a reflection spectrum and/or an absorption spectrum of a material of the carrier element and additionally in part by a color and/or a reflectance and/or a transmittance and/or an absorbance and/or a reflection spectrum and/or an absorption spectrum of an intermediate layer. By adapting properties of both the carrier element and the intermediate layer, a particularly high flexibility of adaptation and/or a particularly high possible adaptation range can be achieved.

Certain values or value ranges of optical parameters of the cover layer and/or the intermediate layer have proven to be particularly advantageous. For example, the cover layer can have a transmittance for the surrounding light of at least 2 percent, preferably at least 5 percent, in particular at least 10 percent, for example at least 20 percent. The intermediate layer can have a transmittance for the surrounding light of at most 5 percent, preferably at most 2 percent, in particular at most 1 percent, and/or a reflectance for the ambient light in the range of 10 to 70 percent.

The cover layer and/or an adhesive layer arranged between the cover layer and the carrier element, in particular between the intermediate layer and the carrier element, can be designed in such a way that a color, in particular the color coordinates a* and b* of the L*a*b* color space, of the surrounding light remain unchanged when passing through the cover layer, i.e. only the brightness value L* is changed.

The operating element can be moved for operation. The cover layer can be a flexible layer so that the operating element can be operated by exerting pressure on the cover layer. For example, the cover layer may comprise a flexible plastic material and/or a textile material and/or leather and/or imitation leather.

The trim part may comprise a light source arranged at least partially within the recess and/or the operating element such that light emitted by the light source passes through the cover layer in the region of the recess. In particular, the light source may comprise a display element, for example an LCD display and/or an OLED display.

It may be provided that the at least one optical property of the contact region is adapted to a corresponding optical property of a surface of the operating element facing the cover layer, in particular is substantially identical thereto. In particular, a reflectance and/or a color, for example a color location in the L*a*b* color space, of the intermediate layer and/or a surface of the carrier element can be substantially identical to a reflectance and/or color of the surface of the operating element facing the cover layer.

### BRIEF DESCRIPTION OF THE DRAWINGS

Exemplary embodiments of the subject matter of the application are explained below with reference to drawings. The drawings each schematically show:

FIG. 1 a cross-section of a trim part,

FIG. 2 a cross-section of a trim part according to a further example.

Recurring and similar features are marked with identical alphanumeric reference numerals in the drawings. Reference numerals already shown in other drawings are partially omitted.

### DETAILED DESCRIPTION

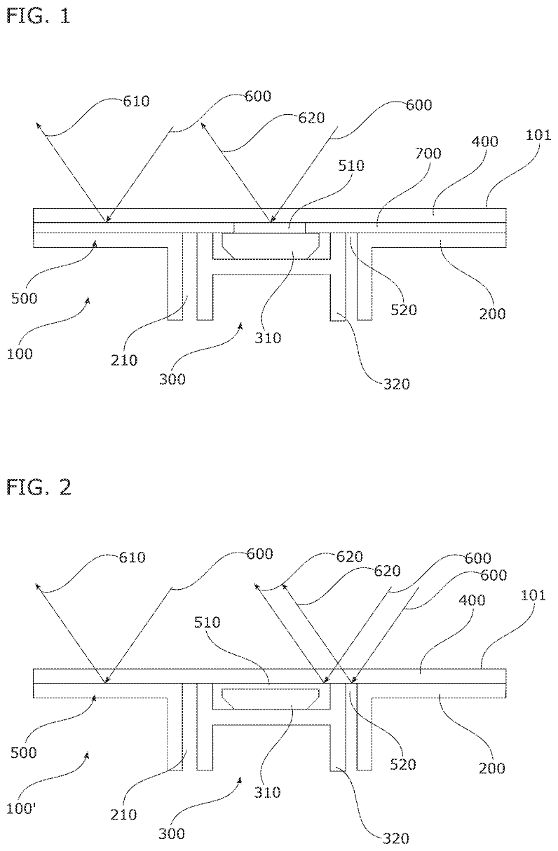

The trim part 100 for a vehicle interior shown in FIG. 1 comprises: a carrier element 200 with a recess 210, an operating element 300 arranged at least partially in the recess 210 of the carrier element 200 and operable from a front side 101 of the trim part 100, and a partially light-transmissive cover layer 400 arranged at the front side 101 of the trim part 100, which covers the recess 210.

The operating element 300 is a movable pressure switch for operation, although other types of operating elements, in particular movable operating elements, may also be provided. The cover layer 400 is a flexible layer made of a plastic material, so that the operating element 300 can be operated by exerting pressure on the cover layer 400. The cover layer 400 may alternatively or additionally comprise, for example, a textile material and/or leather and/or imitation leather.

The trim part 100 comprises a light source 310 disposed within the recess 210 on the operating element 300 such that light emitted from the light source 310 passes through the cover layer 400 in the region of the recess 210. The light source 310 comprises a display element, such as an LCD display or an OLED display. The light source 310 is attached to an operating element substrate 320 of the operating element 300.

The cover layer 400 has an intermediate layer 700 arranged on a side of the cover layer 400 facing the carrier element, by means of which the cover layer 400 is supported on the carrier element 200 in a contact region 500 surrounding the recess 210 and is flatly connected thereto by means of an adhesive. An air gap 510 is formed between the operating element 300 and the cover layer 400, and an air gap 520 is formed between the operating element 300 and the carrier element 200, so that a first part 610 of a visible surrounding light 600 passing through the cover layer 400 from the front side 101 of the trim part 100 is reflected in the contact region 500 and a second part 620 of the surrounding light 600 is reflected in the region of the air gaps 510, 520.

The intermediate layer 700 is formed as a color layer. The intermediate layer 700 may alternatively or additionally be and/or comprise an adhesive layer and/or a textile layer and/or a plastic layer and/or a film layer.

Optical properties of the contact region 500 are selected such that the reflected first part 610 of the surrounding light 600 and the reflected second part 620 of the surrounding light 600 have substantially the same brightness and substantially the same color after passing through the cover layer 400, wherein said brightness and color of the reflected first part of the surrounding light and the reflected second part of the surrounding light are quantifiable as color location in the L*a*b* color space. The property of having substantially the same brightness and/or substantially the same color is defined in such a manner that the distance between two color locations in the L*a*b* color space, denoted as ΔE*_{ab}, is less than 1.

The air gap 510 formed between the cover layer 400 and the operating element 300 is partially covered by the intermediate layer 700, while the air gap 520 formed between the carrier element 200 and the operating element 300 is completely covered by the intermediate layer 700. The intermediate layer 700 thus also acts as a masking layer that masks the air gap 520.

The aforementioned optical properties of the contact region 500 are given by optical properties of the intermediate layer 700 in combination with optical properties of other components; an example of suitable optical properties is given below. The suitable optical properties are substantially determined by the transmittance, reflectance and absorptance of selected materials and can be quantified by measurement. If the ΔE* defined above is less than an empirical distance limit value, in particular 1, it can be assumed that a difference cannot be perceived by the human eye.

The cover layer 400 has a transmittance for the surrounding light 600 of at least 2 percent, preferably at least 5 percent, in particular at least 10 percent, for example at least 20 percent. The cover layer 400 is designed in such a manner that the color coordinates a* and b* of the L*a*b* color space of the surrounding light 600 remain unchanged when passing through the cover layer 400, i.e. only the brightness value L* is changed. The top layer 400 has a gray appearance.

On a surface facing the cover layer 400, the light source 310 has a reflectance for the surrounding light 600 in the range of 10 to 70 percent.

The intermediate layer 700 has a transmittance for the surrounding light 600 of at most 5 percent, preferably at most 2 percent, in particular at most 1 percent. The intermediate layer 700 is designed in such a manner that it has a color (color location in the L*a*b* color space) and a reflectance that substantially correspond to the color and reflectance of the surface of the light source 300 facing the cover layer 400.

In the present example, the light source 310 comprises a surface of the operating element 300 facing the cover layer 400. However, it may alternatively or additionally comprise the operating element substrate 320 of a surface of the operating element 300 facing the cover layer 400. In this case, the intermediate layer 700 should have a color (color location in the L*a*b* color space) and a reflectance substantially corresponding to the color and reflectance of the surface of the control element substrate 320 facing the cover layer 400. The control element substrate 320 may have an additional surface layer, for example with a reflectance for the surrounding light 600 of at least 70 percent and a transmittance for the surrounding light 600 of at most 10 percent, wherein the color coordinates a* and b* of the L*a*b* color space of the surrounding light 600 preferably remain unchanged when passing through the additional surface layer.

The operating element 100′ shown in FIG. 2 corresponds substantially to the operating element 100, but does not comprise an intermediate layer. In this example, the aforementioned optical properties of the contact region 500 are given by optical properties of the carrier element 200 and an adhesive layer flatly affixing the carrier element 200 to the cover layer 400, wherein said optical properties comprise a color and/or a reflectance and/or an absorbance and/or a reflection spectrum and/or an absorption spectrum of a material of the carrier element 200.

### LIST OF REFERENCE NUMERALS

100, 100′ trim part,
101 front side,
200 carrier element,
210 recess,
300 operating element,
310 light source,
320 operating element substrate,
400 cover layer,
500 contact region,
510 air gap,
520 air gap,
600 surrounding light,
610 first part,
620 second part,
700 intermediate layer,

What is claimed is:

1. A trim part for a vehicle interior, comprising:
a carrier element with a recess;
an operating element arranged at least partially in the recess of the carrier element, wherein the operating element is operable from a front side of the trim part; and
a partially light-transmissive cover layer arranged at the front side of the trim part, wherein the cover layer at least partially covers the recess, wherein the cover layer is supported on and/or flatly connected to the carrier element in a contact region surrounding the recess and wherein an air gap is formed between the operating element and the cover layer and/or the carrier element so that a first part of a visible surrounding light, which passes through the cover layer from the front side of the trim part, is reflected in the contact region and a second part of the surrounding light is reflected in a region of the air gap, and wherein at least one optical property of the contact region is chosen in such a way that the reflected first part of the surrounding light and the reflected second part of the surrounding light have, after passing through the cover layer, substantially a same brightness and/or substantially a same color.

2. The trim part according to claim 1, wherein the at least one optical property of the contact region is at least partly given by a color and/or a reflectance and/or a transmittance and/or an absorbance and/or a reflection spectrum and/or an absorption spectrum of a material of the carrier element.

3. The trim part according to claim 1, wherein the at least one optical property of the contact region is at least partly given by a color and/or a reflectance and/or a transmittance and/or an absorbance and/or a reflection spectrum and/or an absorption spectrum of an intermediate layer arranged between the cover layer and the carrier element in the contact region.

4. The trim part according to claim 3, wherein the intermediate layer is applied to a side of the cover layer facing the carrier element in a materially bonded manner, and/or is flatly connected thereto.

5. The trim part according to claim 3, wherein the intermediate layer is or comprises a color layer.

6. The trim part according to claim 3, wherein the intermediate layer is or comprises an adhesive layer, wherein the adhesive layer includes a mixture of color pigments.

7. The trim part according to claim 3, wherein an air gap formed between the carrier element and the operating element is at least partially covered by the intermediate layer.

8. The trim part according to claim 3, wherein the intermediate layer has a transmittance for the surrounding light of at most 5 percent and/or a reflectance for the surrounding light in a range of 10 to 70 percent.

9. The trim part according to claim 1, wherein the cover layer has a transmittance for the surrounding light of at least 2 percent.

10. The trim part according to claim 1, wherein the at least one optical property of the contact region is adapted to a corresponding optical property of a surface of the operating element facing the cover layer and is substantially identical thereto.

11. The trim part according to claim 1, wherein the operating element is movable for operation and/or wherein the cover layer is a flexible layer, so that the operating element is operable by exerting pressure on the cover layer.

12. The trim part according to claim 1, further comprising:
a light source arranged at least partially within the recess and/or the operating element such that light emitted by the light source passes through the cover layer in the region of the recess.
